(19) United States
(12) Patent Application Publication
(10) Pub. No.: US 2026/0370931 A1
(43) Pub. Date: Nov. 19, 2026

(54) ATTACHABLE MIRRORING SCREEN AND METHOD

(71) Applicant: Yodan LEVY, Ramat Gan (IL)

(72) Inventor: Yodan LEVY, Ramat Gan (IL)

(21) Appl. No.: 19/734,215

(22) Filed: Jul. 8, 2026

Related U.S. Application Data
(63) Continuation-in-part of application No. PCT/IL2025/050030, filed on Jan. 9, 2025.

(30) Foreign Application Priority Data
Jan. 10, 2024 (IL) 310075

(51) Int. Cl. H04N 23/63; G06T 3/60; H04M 1/72409; H04N 23/90

(52) U.S. Cl. CPC H04N 23/631; G06T 3/60; H04M 1/72409; H04M 2250/22; H04M 2250/52; H04N 23/90

(57) ABSTRACT

A mirroring display, comprising a screen and an attachment mechanism adapted to detachably attach to the back of a mobile phone. The mirroring display is connected to the mobile phone wirelessly or via a wire, and using a mirroring logic, displays the content of the mobile phone screen on the mirroring display screen such that a user action on the mirroring display has the same effect as if the action had been performed on the mobile phone.

### CROSS REFERENCE TO RELATED APPLICATIONS

This application is a Continuation-in-Part of PCT Patent Application No. PCT/IL2025/050030 having International filing date of Jan. 9, 2025, which claims the benefit of priority of Israeli Patent Application No. 310075, filed Jan. 10, 2024, the contents of which are all incorporated herein by reference in their entirety.

### TECHNICAL FIELD

The present invention relates to mobile telephone screens and in particular to a screen that can be attached at the back of a mobile phone and provide an interactive mirrored view of the mobile phone.

### BACKGROUND ART

Mobile phones are popular personal communication devices that besides being able to place and receive phone calls, can also browse the Internet and take pictures and videos with their built-in cameras. Mobile phones have long become a common companion and users use their mobile phones for a growing number of tasks for both leisure and business. One popular activity of mobile phones users is using social media applications where users can watch, create and upload their own content, be it any combination of text, photos, graphics, effects, videos, sounds, etc. Mobile phones nowadays usually have one or more cameras at the back of the phone and one on the front of the phone, above or on top of the screen. The front camera is usually used to take ‘selfies”, where the user points the front camera towards his face and takes a photo or a video. Since most of the photos and videos on a mobile phone are taken using the rear camera and there is more space at the back of the mobile phone to put more and larger camera sensors, in most cases the rear camera is of a higher quality and resolution compared to the front camera.

### SUMMARY OF INVENTION

The present invention relates to a mirroring display, comprising: (i) a screen; (ii) an attachment mechanism, adapted to detachably attach at the back of a mobile phone; (iii) a communication unit, adapted to communicate with said mobile telephone; and (iv) at least one memory communicatively coupled to at least one processor comprising computer-readable instructions that when executed by the at least one processor run a first mirroring logic adapted to communicate via said communication unit with a second mobile-side coordination logic (e.g., mirroring software application) residing on said mobile phone, configured to maintain bidirectional synchronization between the mirroring display and the mobile phone by rendering an interactive mirrored view and forwarding detected user inputs.

In some embodiments, the screen is a touch screen.

In some embodiments, the communication unit communicates wirelessly.

In some embodiments, the communication unit can communicate wirelessly via Bluetooth, and/or WiFi, and/or any other wireless communication technology or any combination thereof.

In some embodiments, the communication unit communicates via a wired connection.

In some embodiments, when the mobile phone's camera is used in any mobile application, the camera image on the mirroring display touch screen is a reversed mirror image of the image displayed on the screen of the mobile phone.

In some embodiments, the entire screen of the mobile phone is displayed on the mirroring display screen as a reverse (mirrored) image.

In some embodiments, the attachment mechanism comprises one or more of: magnets, clips, or any other detachable attachment device.

In some embodiments, the mirroring display device 10 is integrally formed with or embedded within a mobile phone protective casing. In this configuration, the attachment mechanism 30 (as shown in FIG. 1) comprises the structural housing of the protective casing itself, which is designed to envelop the mobile phone 100. The screen 20 is disposed on the exterior rear surface of the casing, ensuring that when the mobile phone 100 is inserted into the casing, the mirroring display is positioned at the back of the phone without obstructing the rear cameras 110. In this embodiment, the communication unit 40 may utilize a wired connection integrated directly into the casing—such as an internal connector that plugs into the mobile phone's charging port upon insertion—or a wireless connection to facilitate the bidirectional synchronization. This integrated embodiment provides a unified accessory that combines device protection with the interactive mirrored view and control capabilities described herein.

In some embodiments, the mirroring display further comprises one or more actionable hardware buttons.

In some embodiments, the one or more actionable hardware buttons can be activated by one or more actions of: pressing, double-pressing or any other type or combination of button manipulation, switching from one predetermined location to another predetermined location, and turning a dial.

In some embodiments, the mirroring display further comprises a wireless connection to connect to headphones, speakers or other wireless devices.

In some embodiments, the one or more actionable buttons are not hardware buttons, but are icons displayed on said touch screen and programmed to perform one or more actions when activated.

In some embodiments, the one or more actions comprise taking a photograph, starting a video capture, pausing a video capture, ending a video capture and reversing the image displayed on said touch screen.

In another aspect, the present invention relates to a computing system comprising: at least one processor; and at least one memory communicatively coupled to the at least one processor comprising computer-readable instructions that when executed by the at least one processor cause the computing system to implement a method of activating an application of a mobile phone via an attached mirroring display, the method comprising:
(i) detachably attaching a mirroring display to the back of a mobile phone;
(ii) establishing a communication channel between said mobile phone and said mirroring display;
(iii) connecting via said communication channel a first mirroring software application residing on said mobile phone with a second mobile-side coordination logic residing on said mirroring display,
such that the mobile phone screen can be displayed on said screen of said mirroring display, and any user action on said touch screen of said mirroring display has the same effect as if the action had been performed on the mobile phone screen.

### BRIEF DESCRIPTION OF DRAWINGS

FIG. 1 shows an embodiment of a mirroring display of the invention comprising a touch screen, an attachment unit, a communication unit, mirroring software and one or more optional physical buttons.

FIG. 2 shows an embodiment of a mirroring display of the invention attached to the back of a mobile phone.

FIG. 3A shows an embodiment of a mirroring display of the invention attached to the back of a mobile phone by pressure, FIG. 3B shows the back of the mirroring display.

FIG. 4A shows an embodiment of a mirroring display of the invention attached to the back of a mobile phone by two individual clips.

FIG. 4B shows the two clips separately.

FIG. 5A shows an embodiment of a mirroring display of the invention attached to the back of a mobile phone by sliding unto rails.

FIG. 5B shows the rails on the back of a smartphone or a smartphone case.

FIG. 6 is a flowchart of a method of performing an action on Mirroring Display and reproducing the action on a mobile phone.

### DETAILED DESCRIPTION

### General Definitions

The term “mobile-side coordination logic” (sometimes referred to as ‘second mirroring software’) refers to any set of computer-executable instructions, hardware logic, or communication protocols residing on or accessible by the mobile phone. This includes, without limitation, standalone software applications, native operating system (OS) services or components, firmware modules, drivers, application programming interfaces (APIs), middleware, or embedded hardware-level instructions configured to facilitate data exchange, screen data transmission, and command reception between the mobile phone and an external device.

As used herein, references to attaching to the “back of the mobile phone” or the ‘rear of the mobile device’ shall be understood to include attaching directly to the housing of the mobile phone itself, as well as attaching to any intermediate structure, accessory, or protective layer disposed thereon. This includes, but is not limited to, protective cases, shells, skins, covers, adhesive mounting plates, or external batteries that are coupled to the mobile phone. The attachment mechanism of the mirroring display may therefore engage with a corresponding feature on the mobile phone housing, or with a corresponding feature on a protective case surrounding the mobile phone.

The term ‘wired connection’ as used herein refers to any physical, conductive path for data transmission. This include traditional cables (e.g., USB, HDMI, MHL) as well as docking interfaces, pogo pins, or conductive contact points on the mirroring display that form an electrical circuit with corresponding contacts on the mobile phone or its protective case when the devices are brought into physical proximity or alignment, including alignment facilitated by magnets.

The term “live image feed” as used herein refers to a continuous or near-continuous stream of image data representing, in real-time or near-real-time, the visual information captured by one or more sensors of the mobile phone. This includes, without limitation, a viewfinder preview of a camera application, a video stream from a teleconferencing application, or a sequence of processed frames. The “live image feed” may include raw pixel data, compressed video data, or a representation of a graphical user interface (GUI) containing a video element. Furthermore, a live image feed may be “reversed” or “mirrored” by the first mirroring logic to provide a reflective visual experience for a user positioned in front of the mobile phone's rear-facing camera.

The term ‘interactive mirrored view’ refers to a visual representation on the mirroring display that corresponds to the data, application, or content of the mobile phone. This ‘view’ may be a pixel-for-pixel copy of the mobile phone screen, a similar or reformatted interface, a different custom interface, or a display of only specific data (such as a camera feed). An ‘interactive mirrored view’ can be rendered on the mirroring display even when the mobile phone's own primary screen is turned off or inactive, provided the mobile phone is processing the underlying data.

The term ‘laterally reversed’ (or ‘reflected orientation’) as used herein refers to a visual transformation of the interactive mirrored view wherein the display is flipped along a vertical axis. In this orientation, elements that would appear on the left side of the mobile phone's native display are rendered on the right side of the mirroring display, and vice versa, mimicking the reflection of a physical mirror. This lateral reversal is specifically intended to provide the user with a natural ‘mirror-like’ experience when utilizing the mobile phone's rear-facing cameras for self-capture (e.g., selfies), ensuring that the user's movements on the screen align with their physical perspective. Crucially, when the interactive mirrored view is laterally reversed, the first mirroring logic or the mobile-side coordination logic is configured to perform a coordinate transformation on detected user inputs. This ensures that a touch input on the right side of the mirroring display is mapped correctly to the logical element appearing on the right side of the mirrored view, even though that element would natively reside on the left side of the mobile phone screen.

The term ‘execution parity’ as used herein refers to a functional state where a user input detected on the mirroring display results in a command execution within the mobile phone's operating system or application that is logically identical to the result that would have been achieved had the input been performed directly on the mobile phone's native interface.

The term ‘coordinate transformation’ refers to the algorithmic re-mapping of touch input coordinates detected on the mirroring display to corresponding logical coordinates on the mobile phone, specifically accounting for differences in screen resolution, aspect ratio, or lateral reversal (mirroring) applied to the interactive mirrored view.

### Modes for Carrying out the Invention

In the following detailed description of various embodiments, reference is made to the accompanying drawings that form a part thereof, and in which are shown by way of illustration specific embodiments in which the invention may be practiced. It is understood that other embodiments may be utilized, and structural changes may be made without departing from the scope of the present invention.

The present invention relates to a mirroring display device adapted to enable a user to use one or more applications on his mobile phone, while looking at and manipulating the touch screen of the mirroring display device. In addition, the user can open the mobile phone rear camera (from the mobile phone or from the mirroring display) and then by looking at the mirroring display, make sure that the captured image or video fit the scene he wished to capture. The mirroring display device of the invention comprises a touch screen, an attachment mechanism to detachably attach at the back of a mobile phone, and a communication unit so that a mirroring logic on the mirroring display can communicate with a mobile-side coordination logic on the mobile phone to provide an interactive mirrored view.

Any action performed by the user on the touch screen of the mirroring display including but not limited to opening an application, clicking or double-clicking anywhere on the touch screen, dragging an image, typing text, swiping to any direction, enlarging or reducing an image, all these user actions have the effect as if being performed on a connected mobile phone.

Similarly, the first mirroring logic and the mobile-side coordination logic maintain bidirectional synchronization, such that the interactive mirrored view reflects the application state of the mobile phone, and user inputs on the mirroring display trigger corresponding execution on the mobile phone. The mirroring display device and the mobile phone are connected via a wireless and/or wired connection.

Typically, the mirroring display device is designed such as that it does not cover the mobile phone's rear cameras (also known as “main cameras”), such that a user may use the mobile phones rear cameras for taking pictures of himself (AKA “selfies”), since the mobile phones rear cameras are typically of better quality than the mobile phone's front cameras.

In some embodiments, only part of the mobile phone screen is reproduced on the mirroring display screen, for example, the camera application.

In some embodiments, mirroring the display of the mobile phone onto the screen of the mirroring display is adapted to the special features of the mirroring display screen, including but not limited to the size and resolution of the mirroring display screen.

One example where the mirroring device is very useful is when a user wishes to take a picture or a video of himself, a practice known as “selfie”. The practice of “selfie” is very common in social networks, where users upload pictures or videos of themselves. Taking selfies can be achieved either by the user holding the phone away by hand or by placing the phone on a stick with a handle on one side and a mechanism to hold the phone on the other side (colloquially known as “selfie stick”) or by placing the phone on a tripod or in any location such as on a table. Taking a selfie implies using the front camera of the mobile phone (the front camera is usually found centered on the top of the screen of the mobile phone).

The front camera of a mobile phone (sometimes referred to as “selfie camera”) is typically of lower resolution and quality compared to the back camera, with which users normally take pictures and videos. Some people wish to take higher quality selfies (stills or video), for example, people who upload frequent content to social networks and earn revenues from followers and viewers. Such people sometimes prefer to use the back camera installed on a tripod or similar holding device, and then either use a timer and take position in front of the phone or activate the camera on video, and then walk away to position themselves in front of the phone. The main problem with these approaches is that the user in front of the phone cannot see himself on the phone screen, and thus cannot be sure if the photo or video shows him correctly as he intended to. Sometimes, such users need multiple takes before one photo or video is to their satisfaction, in terms of capturing the user in the right frame or the right pose.

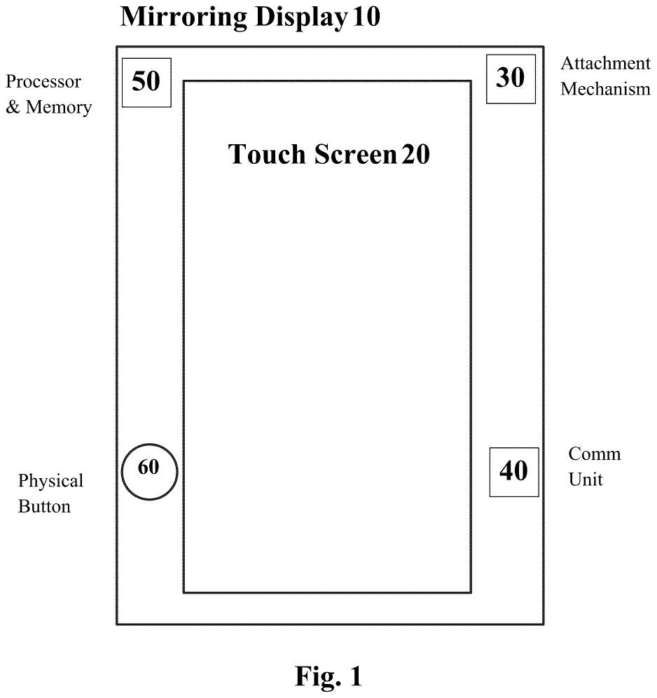

FIG. 1 illustrates a mirroring display device 10 comprising a screen 20 preferably a touch screen, an attachment mechanism 30, a communication unit 40, at least one processor and memory 50 comprising computer-readable instructions that when executed by the at least one processor run a first mirroring logic, and optionally one or more physical buttons 60, of any type, including but not limited to pressure buttons, dials, sliders, and capacitive buttons.

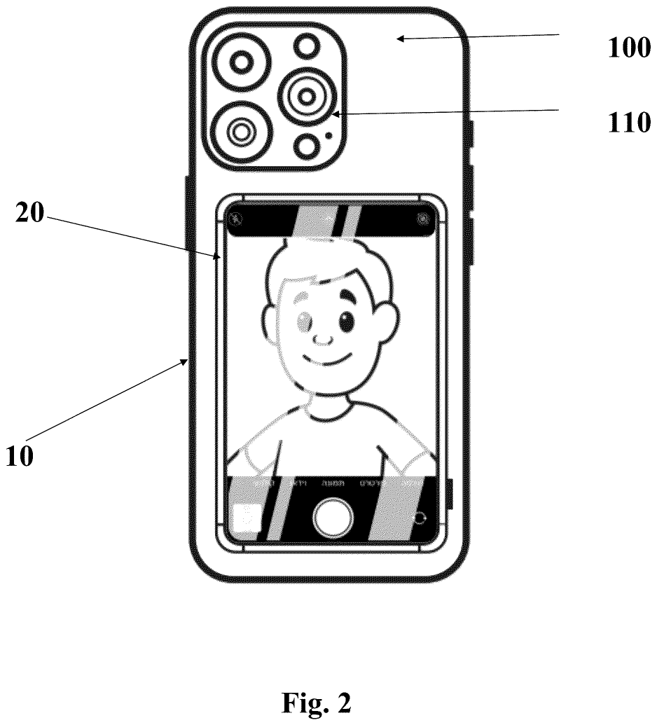

As illustrated in FIG. 2, the mirroring display device 10 is adapted to detachably connect to the back of a mobile phone 100 so the mobile phone's back camera 110 can be used for taking selfies pictures or videos.

The mirroring display device 10 detachably connects to the back of a mobile phone 100 via an attachment mechanism. The attachment mechanism can be implemented in many ways, and a person skilled in the art could easily devise other embodiments to the attachment mechanism.

Attachment mechanism example 1, using magnets—the mirroring display device 10 can detachably connect to the back of a mobile phone 100 via magnets. A first magnet at the back of the mobile phone 100 and a second magnet at the back of the mirroring display device 10. The magnets can either be an integral part of the mobile phone 100 (as with the new iPhone™ models) or added afterwards via a sticker or similar adhesive options.

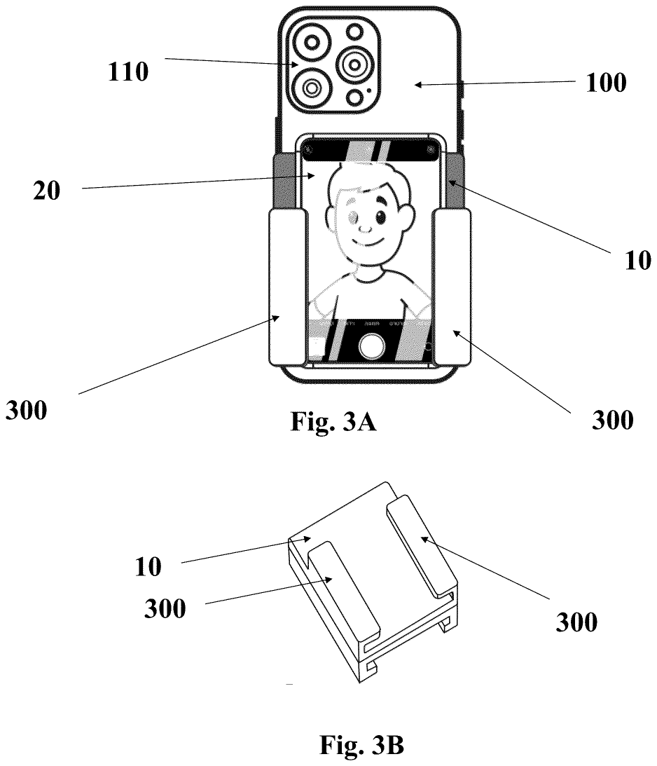

Attachment mechanism example 2, using integrated clipping sidewalls—the mirroring display device 10 can be made to include left and right sidewalls with some elasticity, that can envelop the mobile phone 100 and clasp to it via pressure. FIG. 3A illustrates such an embodiment showing the two sidewalls 300 enveloping (clipping) the mobile phone 100 on both sides. The sidewalls 300 are made to be elastic enough that they can by pulled away slightly to clip or unclip (attach/detach) the mobile phone 100. Thus, the mirroring display device 10 can thus detachably connect and disconnect from the mobile phone 100 by bending one or two sidewalls 300 open slightly to connect or release the mobile phone 100. FIG. 3B illustrates the back of the mirroring display device 10. In some embodiments, the mirroring display device 10 can be integrated into a mobile phone protective casing.

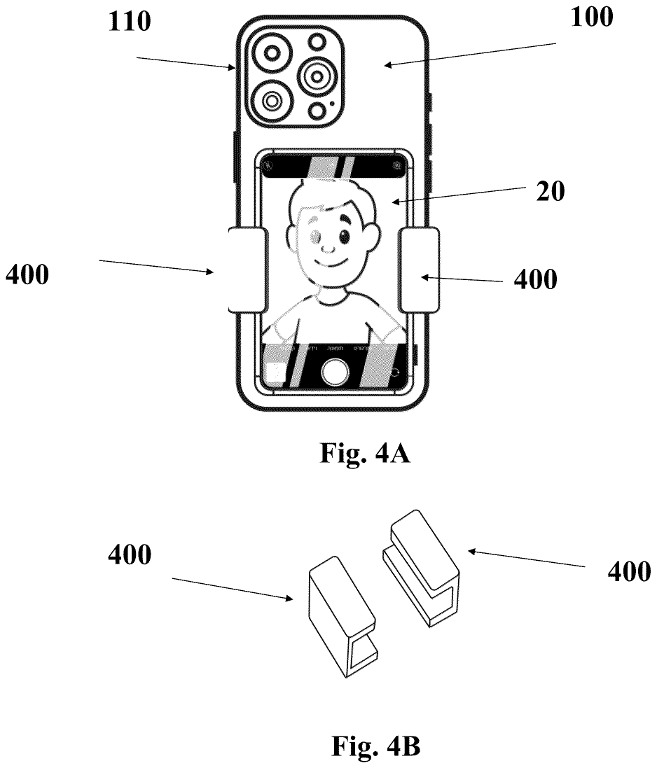

Attachment mechanism example 3, using separated clips—as illustrated in FIG. 4A, the mirroring display device 10 can be attached to the mobile phone 100 via two separated clips 400 that clasp the two devices 10, 100 together via pressure. The clips 400 are made to be elastic enough that they can by pulled away slightly to clip or unclip (attach/detach) the mobile phone 100. Thus, the mirroring display device 10 can thus detachably connect and disconnect from the mobile phone 100 by bending each clip 400 open slightly to connect or release the mobile phone 100. FIG. 4B illustrates the two clips 400 individually.

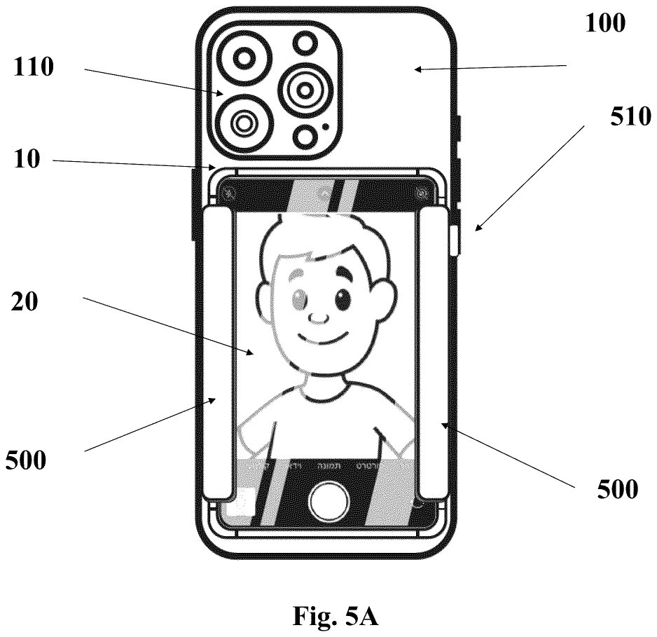

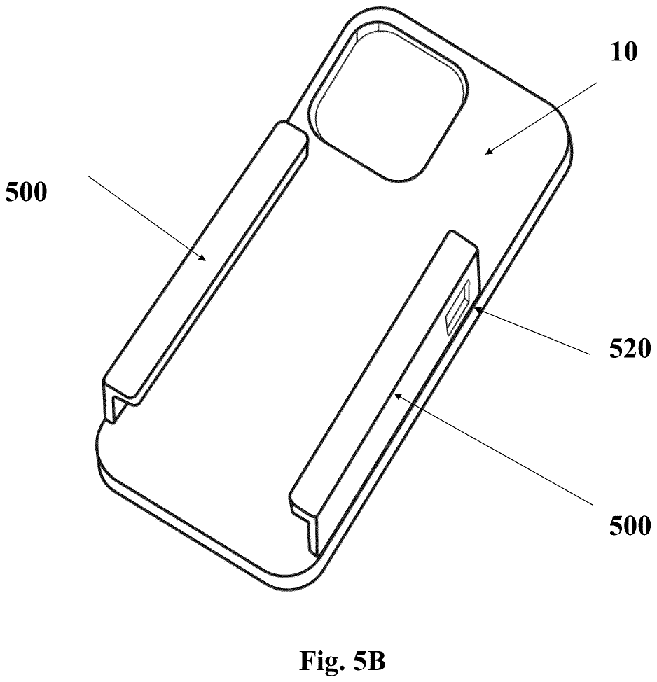

Attachment mechanism example 4, using rails—the mirroring display device 10 can detachably connect to the back of a mobile phone 100 via rails. FIG. 5A shows an embodiment of an attachment mechanism where the mobile phone's 100 back has left and right rails 500 into which the mirroring display device 10 can be inserted to and released from. The rails 500 can be implemented in many ways, for example, the rails 500 can be like a casing comprising one portion connected to the narrow side of the mobile phone 100 and another portion (perpendicular to the first portion) extending above the back of the mobile phone 100, where the mirroring display device 10 is inserted underneath the second portion of the rail 500. To better hold the mirroring display device 10 under the rail 500, a protruding safety pin 510 (one or more) can be pressured in when the mirroring display device 10 is inserted into the rails, and retracted when reaching a matching opening 520 (shown in FIG. 5B) in the rail 500, thus securing that the mirroring display device 10 does not move easily after insertion. Alternatives to the safety pin 510 can be implemented in many ways, for example, a gap that an elastic protrusion in the mirroring display device 10 can fit inside, and thus prevent sliding out of the mirroring display device 10.

The mobile phone 100 and the mirroring display device 10 communicate via a communication channel established by the communication unit 40. The communication channel is preferably wireless using one or more industry protocols including but not limited to Wi-Fi or Bluetooth™ or any other present or future wireless communication protocol. Alternatively, the communication channel established may be wired, or both wired and wireless.

The mirroring software application of the mirroring display device 10 communicates with another mirroring software application residing on the mobile phone 100, over the established communication channel or channels.

Mirroring software allows to replicate the content of the screen of one device on the screen of another device. Hence the contents of the screen of the mobile phone 100 are displayed on the touch screen 20 of the mirroring display device 10.

In some embodiments, the interactive mirrored view is generated by rendering a user interface that differs from the native user interface of the mobile phone that can be more appropriate for using a particular touch screen 20. The difference in UI choices may involve using different fonts, different colors, changing the proportion of objects, adding or removing elements or objects, changing the position of objects etc. It should be understood that the interactive mirrored view may encompass a literal pixel-for-pixel replication of the mobile phone's entire display, a similar interface (e.g. different aspect ratio, size and location of objects, etc.) or a customized rendering of the mobile phone content. In the latter case, the first mirroring logic generates the display by selectively extracting a subset of data from the mobile phone, rather than capturing a literal video feed of the mobile phone screen. This allows the mirroring display to present ‘partial data’—for example, extracting only the camera viewfinder data, metadata (such as battery levels or notifications), or a specific application's data fields—while omitting other elements of the mobile phone's native display. This selective extraction, which may be customized by the user, enables the mirroring display to reconstruct and render an interactive mirrored view that is optimized for the mirroring display's form factor and user experience (e.g. Apple CarPlay and Android Auto).

The interactive mirrored view described herein may be implemented according to various technical modes to optimize data transmission and user experience. In a first exemplary mode, referred to as ‘Literal Mirroring,’ the first mirroring logic renders a pixel-for-pixel replication of the mobile phone's entire primary display, providing a high-fidelity visual carryover of the current device state. In a second exemplary mode, referred to as ‘Selective Mirroring,’ the first mirroring logic is configured to extract only a discrete subset of data or specific application components from the mobile phone for rendering on the screen. This may include, for example, extracting only the live camera viewfinder feed and associated metadata (e.g., capture settings, battery level) while omitting other native system UI elements such as notifications or status bars. In a third exemplary mode, referred to as ‘Reformatted Mirroring,’ the first mirroring logic performs a technical transformation of the application data to suit the hardware parameters of the mirroring display. This involves re-rendering the user interface by modifying one or more of: font sizes, object proportions, color profiles, or the relative positioning of graphical interface elements. By utilizing these modes, the mirroring display can transition between a literal duplicate of the phone screen and an optimized interface tailored specifically for the size, resolution, and aspect ratio of the mirroring display's screen, thereby improving legibility and interaction efficiency.

In a further aspect of the invention, the mirroring display is configured to display data and receive user inputs even while the primary screen of the mobile phone is in an inactive state, a power-saving mode, or is completely turned off (i.e., ‘blacked out’). In this ‘headless’ mode, the host-side interaction module on the mobile phone retrieves relevant data and transmits it to the mirroring display without needing to illuminate or render that data on the mobile phone's own screen. This serves to conserve the mobile phone's battery life, reduce heat generation, and prevent accidental touches on the mobile phone screen while it is attached to or being controlled by the mirroring display. To facilitate this, the mobile-side coordination logic maintains an active data session over the communication channel even when the mobile phone's display driver for its primary screen is in a low-power state or instructed to cease rendering, thereby allowing the first mirroring logic to continue rendering the interactive mirrored view independently.

The mirroring software application of the mirroring display device 10 of the invention does not only duplicate the mobile phone's 100 screen on the touch screen 20 of the mirroring display device 10, but most importantly enables the user to use any application available on the mobile phone 100 by performing similar user actions on the touch screen 20, for example, opening an application, clicking or double clicking on an icon or any other object on the screen, sliding, selecting, manipulating a physical button 60 and other user actions.

Screen mirroring (also referred to at times as “casting”) can be achieved via wireless or wired connections.

Known wireless mirroring technologies today include:
(1) Wi-Fi Direct—A technology that enables devices to establish a direct Wi-Fi connection without the need for a traditional Wi-Fi network. Devices supporting Wi-Fi Direct can connect directly to each other, making it simple and convenient to print, share, sync, play games, and display content to another device.

Miracast is a standard for wireless display mirroring that uses Wi-Fi Direct. Miracast enables seamless display of multimedia content between Miracast® devices. Miracast allows users to wirelessly share multimedia, including high-resolution pictures and high-definition (HD) video content between Wi-Fi devices, even if a Wi-Fi network is not available.
(2) AirPlay is a proprietary protocol developed by Apple™. It allows iOS and macOS devices to wirelessly mirror their screens and stream media to an Apple TV™ or other AirPlay-enabled devices.
(3) Google Cast (Chromcast) is a technology developed by Google™ that enables users to cast their screens or specific content from a mobile device or computer to a compatible display, such as a Chromecast-enabled TV.
(4) Bluetooth™—Though Bluetooth™ is more commonly used for audio devices, some screen mirroring solutions use Bluetooth™ for initial device pairing or connection setup.

Known wired mirroring technologies today include:
(1) HDMI or USB-C—High-Definition Multimedia Interface (HDMI) is a common wired connection for screen mirroring. It requires an HDMI cable to connect the mobile device to a display that supports HDMI input.

USB-C: Some newer smartphones use USB-C ports that support video output. With a USB-C to HDMI or DisplayPort adapter, users can connect their phones directly to a display.
(2) MHL (Mobile High-Definition Link) is a standard that allows compatible smartphones and tablets to connect to HDTVs and displays using an MHL cable. It supports both audio and video transmission.

When the mobile telephone 100 camera is used in any mobile application, normally the interactive mirrored view displayed on the touch screen 20 is laterally reversed relative to the native display orientation of the mobile phone. This lateral reversal allows the user to perceive the live image feed as if looking into a physical mirror, which is particularly advantageous when using the mobile phone's rear-facing cameras for self-capture.

In some embodiments, the mirroring display 10 comprises one or more actionable physical hardware buttons 60 that their manipulation can trigger a predetermined action, for example, taking a photograph, starting a video, pausing a video, stopping a video etc. The one or more actionable hardware buttons 60 can be activated by one or more actions of: pressing, double-pressing, or any other type or combination of button manipulation, switching from one predetermined location to another predetermined location, and turning a dial.

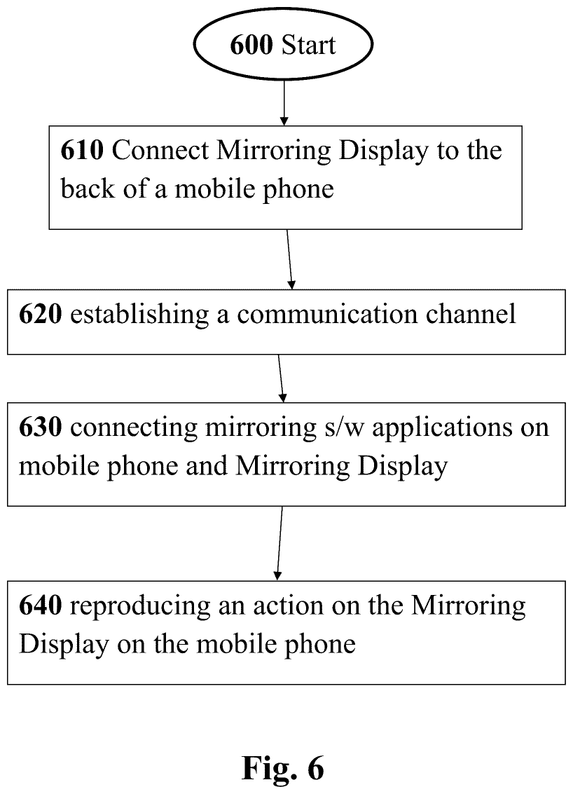

In another aspect, the present invention relates to a method of activating an application of a mobile phone via an attached mirroring display, as is shown in FIG. 6. In step 600 the process starts. In step 610 the mirroring display device 10 is connected (attached) to the back of a mobile phone 100. In step 620 a communication channel is established between the mirroring display device 10 and the mobile phone 100. The communication channel may be wireless, wired or both. In step 630 a first mirroring logic residing on the mirroring display 10 connects with a second mobile-side coordination logic residing on the mobile phone 100. Once the two mirroring software applications are connected information can be shared between the mobile phone 100 and the mirroring display device 10. In step 640 bidirectional synchronization is established to provide the interactive mirrored view and facilitate execution parity for user input.

In some embodiments, the user can detach the mirroring display device 10 from the mobile phone 100 and use the mirroring display device 10 as a remote control for operating the mobile phone 100. For example, the user might place the mobile phone on a tripod (or stabilize it on any location) and then stand in front of the phone. The user uses the mirroring display device 10 both to observe what is captured by the phone's camera 110 and to take a photograph or start/pause/end a video.

In some embodiments, touch screen 20 displays one or more actionable icons to assist the user in certain actions. For example, one icon can take a photo when pressed, another icon can start or pause or end a video capture, while another icon can reverse the image displayed on the touch screen 20.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media in several manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel.RTM. Pentium.RTM. or Centrino.TM. processor, that are adapted to communicate with the computer. Any number and type of machines may be in communication with the computer.

1. A mirroring display, comprising:
(i) a screen configured to detect user touch inputs;
(ii) an attachment mechanism, adapted to detachably attach at the back of a mobile phone;
(iii) a communication unit, adapted to communicate with said mobile telephone; and
(iv) at least one memory communicatively coupled to at least one processor comprising computer-readable instructions that when executed by the at least one processor configure the at least one processor to provide a first mirroring logic adapted to communicate via said communication unit with a second mobile-side coordination logic on said mobile phone,
wherein the first mirroring logic is configured to maintain bidirectional synchronization with the mobile phone by: (a) rendering an interactive mirrored view of the mobile phone based on application data received from the mobile phone, wherein the interactive mirrored view is formatted to correspond to a size and a resolution of the screen; and (b) forwarding user inputs detected on the screen to the mobile-side coordination logic to trigger corresponding execution on the mobile phone.

2. The mirroring display according to claim 1, wherein said screen is a touch screen.

3. The mirroring display according to claim 1, wherein when the mobile phone's camera is used in any mobile application, the camera image on the mirroring display screen is a reversed mirror image of the image displayed on the screen of the mobile phone.

4. The mirroring display according to claim 1, wherein the interactive mirrored view is laterally reversed relative to a native display orientation of the mobile phone.

5. The mirroring display according to claim 1, wherein said attachment mechanism comprises one or more: magnets, clips, or any other detachable attachment device.

6. The mirroring display according to claim 1, further comprising one or more actionable hardware buttons, configured so that their manipulation can trigger a predetermined action.

7. The mirroring display according to claim 6, wherein the one or more actionable hardware buttons can be activated by one or more actions of: pressing, double-pressing or any other type or combination of button manipulation, switching from one predetermined location to another predetermined location, and turning a dial.

8. The mirroring display according to claim 1, wherein one or more actionable icons are displayed on said screen by the first mirroring logic and programmed to perform one or more actions when activated.

9. The mirroring display according to claim 8, wherein said one or more actions comprise taking a photograph, starting a video capture, pausing a video capture, ending a video capture and reversing the interactive mirrored view displayed on said screen.

10. The mirroring display according to claim 1, wherein data displayed on the mobile phone can be displayed on said screen of said mirroring display with a different user interface rendered by the first mirroring logic.

11. A computing system comprising:
at least one processor; and
at least one memory communicatively coupled to the at least one processor comprising computer-readable instructions that when executed by the at least one processor cause the computing system to implement a method of activating an application of a mobile phone via an attached mirroring display, the method comprising:
(i) detachably attaching a mirroring display comprising a screen at the back of a mobile phone;
(ii) establishing a communication channel between said mobile phone and said mirroring display;
(iii) connecting via said communication channel a first mirroring logic residing on the mirroring display with a second mobile-side coordination logic on the mobile phone,
wherein the first mirroring logic maintains bidirectional synchronization with the mobile phone by: (a) rendering an interactive mirrored view of the mobile phone; and (b) forwarding user inputs detected on the screen to the mobile-side coordination logic to trigger corresponding execution by the mobile phone.

12. The computing system according to claim 11, wherein said screen of said mirroring display is a touch screen configured to detect user inputs for the first mirroring logic.

13. The computing system according to claim 11, wherein when the mobile phone's camera is used in any mobile application, the camera image on the mirroring display is a reversed mirror image of the image displayed on the screen of the mobile phone regardless of whether the primary screen of the mobile phone is in an active or inactive state.

14. The computing system according to claim 11, wherein the interactive mirrored view is laterally reversed relative to a native display orientation of the mobile phone.

15. The computing system according to claim 11, wherein said attachment mechanism comprises one or more: magnets, clips, or any other detachable attachment device.

16. The computing system according to claim 11, further comprising one or more actionable hardware buttons.

17. The computing system according to claim 16, wherein the one or more actionable hardware buttons can be activated by one or more of actions of: pressing, double-pressing or any other type or combination of button manipulation, switching from one predetermined location to another predetermined location, and turning a dial.

18. The computing system according to claim 11, wherein one or more actionable icons are displayed on said screen and programmed to perform one or more actions when activated.

19. The computing system according to claim 18, wherein said one or more actions comprise taking a photograph, starting a video capture, pausing a video capture, ending a video capture and reversing the image displayed on said mirroring display screen.

20. The computing system according to claim 11, wherein data displayed on the mobile phone screen can be displayed on said screen of said mirroring display with a different user interface.

21. A mirroring display device, comprising:
(i) a screen;
(ii) an attachment mechanism, adapted to detachably attach at the back of the mobile phone, such that the mirroring display device does not cover the mobile phone's rear cameras;
(iii) a communication unit, adapted to communicate with said mobile telephone; and
(iv) at least one memory communicatively coupled to at least one processor comprising computer-readable instructions that when executed by the at least one processor run a first mirroring logic adapted to communicate via said communication unit with a second mobile-side coordination logic on said mobile phone,
wherein the first mirroring logic is configured to maintain bidirectional synchronization with the mobile phone by: (a) rendering an interactive mirrored view of a camera application; and (b) forwarding user inputs detected on the screen to the mobile-side coordination logic to trigger corresponding execution of camera functions by the mobile phone.

22. The mirroring display device of claim 21, wherein user actions comprise taking a photograph, starting a video capture, pausing a video capture, ending a video capture, laterally reversing the interactive mirrored view, or any combination thereof.
